(19) United States
(12) Patent Application Publication
(10) Pub. No.: US 2017/0370088 A1
(43) Pub. Date: Dec. 28, 2017

(54) TOILET INSTALLATIONS

(71) Applicant: Boxes Direct Limited, Walsall (GB)

(72) Inventors: Mark Andrew Jones, West Midlands (GB); Julie Jones, West Midlands (GB); Joseph Doyle, Walsall (GB); Maurice Doyle, Walsall (GB)

(21) Appl. No.: 15/632,908

(22) Filed: Jun. 26, 2017

Related U.S. Application Data
(60) Provisional application No. 62/354,179, filed on Jun. 24, 2016.

(51) Int. Cl. E03D 11/17; F16K 31/12; F16K 15/02

(52) U.S. Cl. CPC E03D 11/17; F16K 15/028; F16K 31/12

(57) ABSTRACT

A method of controlling the discharge of waste water from a toilet includes the installation of a valve in the discharge outlet of the toilet, the valve including a valve body and a spring-loaded valve closure member that is movable relative to the valve body into an open position during flushing of the toilet against the action of its spring-loading and which is returned to the closed position by the action of its spring-loading on completion of the flushing operation.

### CROSS-REFERENCE TO RELATED APPLICATION

This application claims priority under 35 USC §119 to U.S. Provisional Patent Application No. 62/354,179 filed on Jun. 24, 2017, which application is hereby incorporated by reference in its entirety.

### FIELD OF THE INVENTION

This invention relates to toilet installations.

The invention is more specifically concerned with a valve for fitment to either the back of the toilet outlet on a P-trap toilet or on the bottom outlet of an S-trap outlet. The trap is the bend in the pipe where the waste water goes out of the toilet.

The bend retains some water after flushing, thus acting as a seal and preventing sewer gases from entering the dwelling in which the toilet is installed.

It is an object of the present invention to provide an improved method and means for controlling the discharge of waste water from a toilet.

### SUMMARY OF THE INVENTION

According to a first aspect of the present invention there is provided a method of controlling the discharge of waste water from a toilet which includes the installation of a valve in the discharge outlet of the toilet, the valve including a valve body and a spring-loaded valve closure member that is movable relative to the valve body into an open position during flushing of the toilet against the action of its spring-loading and which is returned to the closed position by the action of its spring-loading on completion of the flushing operation.

The valve body is preferably formed as a plastic moulding from a non-transparent material, and preferably includes a planar fixing portion formed with slots through which fasteners can be passed for securing the valve in the required position.

The valve body preferably also includes a generally frusto-conical portion on which the valve closure member is mounted.

According to a second aspect of the present invention there is provided means for controlling the discharge of waste water from a toilet comprising a valve for fitment in the discharge outlet of the toilet, the valve including a valve body and a spring-loaded valve closure member that is movable relative to the valve body into an open position during flushing of the toilet against the action of its spring-loading and which is returned to the closed position by the action of its spring-loading on completion of the flushing operation.

### BRIEF DESCRIPTION OF THE DRAWINGS

FIGS. 1, 2 and 3 show a first embodiment of valve in its closed condition,

FIGS. 4, 5 and 6 show the valve of FIGS. 1 to 3 in its open condition,

FIGS. 7, 8 and 9 show the valve of FIGS. 1 to 3 fitted in position in its closed condition,

FIGS. 10, 11 and 12 show the valve of FIGS. 1 to 3 fitted in position in its open condition,

FIG. 13 is a plan view of a second embodiment of valve in its closed position, and

FIG. 14 is a side view of the valve shown in FIG. 13.

### DESCRIPTION OF THE PREFERRED EMBODIMENT

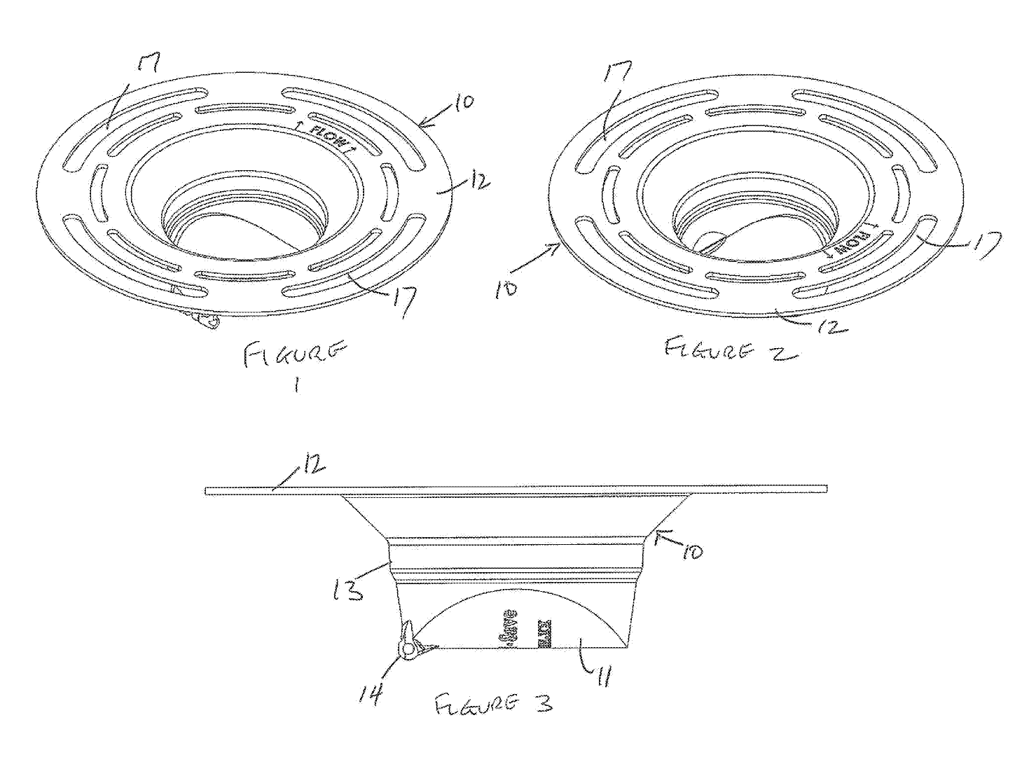

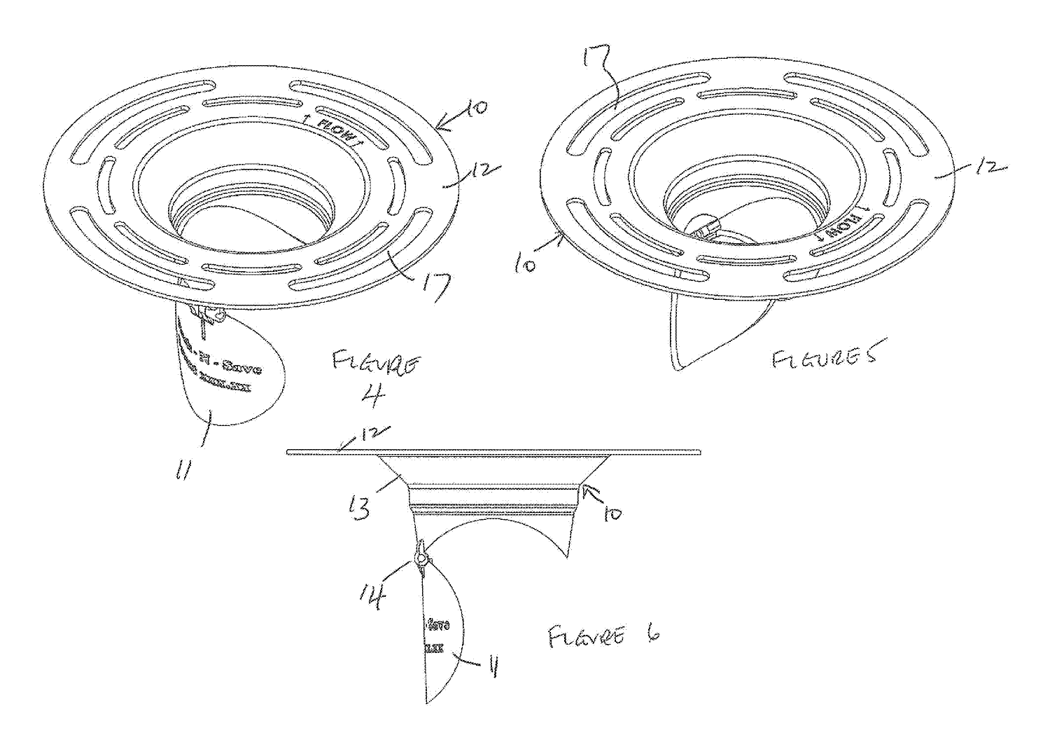

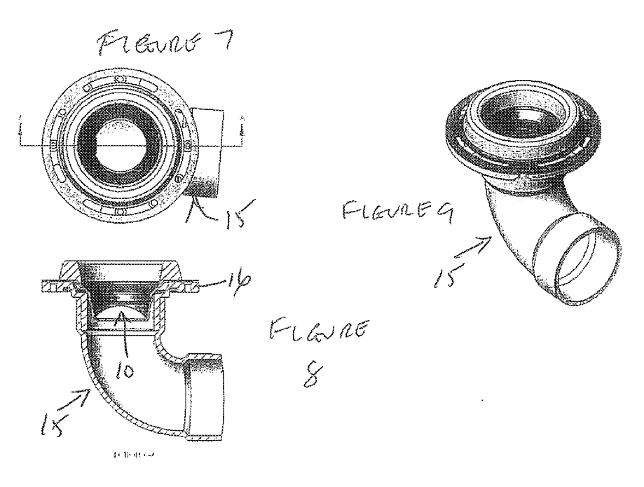

The valve shown in FIGS. 1 to 6 includes a valve body 10 and a lid or valve closure member 11, each formed as plastic mouldings from a non-transparent material. The valve body 10 includes a circular flange 12 and a tapered housing 13 to the lower end of which the valve closure member 11 is connected by means of a hinge 14. As can be seen from FIGS. 1 to 3, the valve closure member 11 is of a curvate configuration and the lower rim of the tapered housing 13 is of a corresponding configuration.

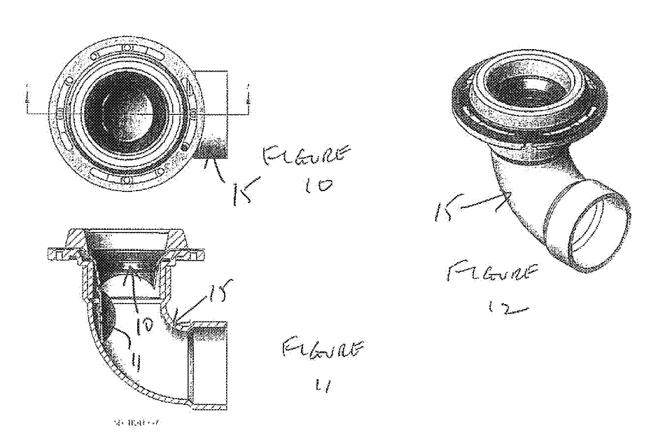

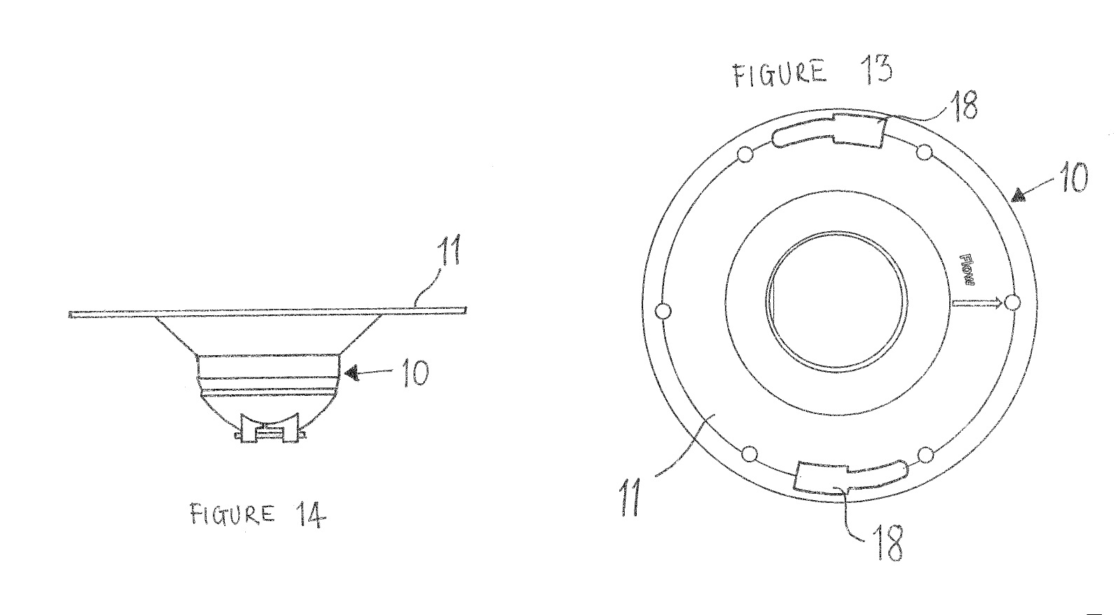

As shown in FIGS. 7 to 12, the valve is connected to the discharge outlet 15 of a toilet using a fixing plate 16 which is secured to the floor of a building to hold the toilet in the required position. The valve is fixed by means of the fixing screws (not shown) that are normally used to locate the toilet and screw the toilet in place. The fixing screws pass through selected ones of a plurality of arcuate openings 17 extending around the flange 12 of the valve. This means that the valve can be fitted in any direction allowing the flow to have a maximum opening potential. A layer of wax (to assist sealing) may be applied to the underside of the flange 12 before it is placed in position.

The valve shown in FIGS. 13 and 14 differs from that shown in FIGS. 1 to 12 in that, instead of having an array of arcuate openings 17 through which fixing screws can be passed, it includes just two slots 18 that are disposed diametrically opposite to one another and which both include portions of different widths to enable the valve to be fixed extremely accurately and securely in position using fasteners of appropriate dimensions.

The design of the valve is such that it can be used with three inch diameter pipes as well as four inch diameter pipes. This is made possible because of the small opening of the funnel which then houses the curved lid or valve closure member. The tapered housing 13 of the valve has a configuration such that, when the toilet is being flushed, it progressively reduces the diameter of the passage through which the waste water can pass. This causes air to mix with the water in the toilet bowl.

This is what is known as the “Bernoulli Effect”, i.e. a mixture of air and water is produced which is forced through a smaller gap or barrier stopping the formation of a vortex when the toilet is flushed. This means that it is possible to reduce the volume of water that is used to flush the toilet by up to 50%. The air mixing with the water when flushing the toilet will clean the toilet taking away any solid waste using a minimum volume of water.

As mentioned above, the valve as a whole is made from a plastic material with the curved valve closure member 11 having a pivot pin formed of marine 316 stainless steel. A spring made of the same material is used to bias the curved lid or valve closure member into the closed position as shown inn FIGS. 1 to 3 and 7 to 9. The rating of the spring is such as to permit ready movement of the curved valve closure member 11 into its open position when the toilet is flushed. This open position is shown in FIGS. 4 to 6 and 10 to 12.

When the curved valve closure member 11 is in its closed position, it will prevent the passage of light from the interior of the toilet bowl into the pipe bend. Light penetration of a pipe bend is known to attract snakes, rats and other vermin. In addition to preventing light penetration into the pipe bend, the curved valve closure member will provide a physical barrier, when in its closed position, preventing snakes, rats and other vermin from gaining access to the home or workplace from the sewer system via the toilet.

After the flushing operation has been completed, an opened curved valve closure member 11 will return to its closed position under the action of its spring, thus stopping any significant backflow returning to the toilet bowl, i.e. stopping all solid matter and at least 98% of liquid matter.

There are times when two toilets are installed back to back, i.e. on either side of a dividing wall. If each of the toilets is fitted with a valve in accordance with the present invention, any cross-flow contamination between the toilets will be prevented. This can be of particular importance in, for example, a block of flats.

What is claimed is:

1. A method of controlling the discharge of waste water from a toilet which includes the installation of a valve in the discharge outlet of the toilet, the valve including a valve body and a spring-loaded valve closure member that is movable relative to the valve body into an open position during flushing of the toilet against the action of its spring-loading and which is returned to the closed position by the action of its spring-loading on completion of the flushing operation.

2. The method as claimed in claim 1, in which the valve body is formed as a plastic moulding from a non-transparent material.

3. The method as claimed in claim 2, in which the valve body includes a planar fixing portion formed with slots through which fasteners can be passed for securing the valve in the required position.

4. The method as claimed in claim 3, in which the valve body also includes a generally frusto-conical portion on which the valve closure member is mounted.

5. A valve for controlling the discharge of waste water from a toilet, the valve dimensioned for fitment in the discharge outlet of the toilet, the valve further comprising a valve body and a spring-loaded valve closure member that is movable relative to the valve body into an open position during flushing of the toilet against the action of its spring-loading and which is returned to the closed position by the action of its spring-loading on completion of the flushing operation.

6. The valve as claimed in claim 5, in which the valve body is formed as a plastic moulding from a non-transparent material, the valve body including a planar fixing portion formed with slots through which fasteners can be passed for securing the valve in the required position, and a generally frusto-conical portion on which the valve closure member is mounted.

7. The valve as claimed in claim 6, in which there are two slots formed in the fixing portion of the valve body and the slots are disposed diametrically opposite to one another.
